(19) United States
(12) Patent Application Publication
(10) Pub. No.: US 2005/0132675 A1
(43) Pub. Date: Jun. 23, 2005

(54) Device for filtering of the air flow in pneumatic systems

(75) Inventor: Marco Lucidera, Rodengo Saiano BS (IT)

Correspondence Address: Shlesinger & Fitzsimmons, Suite 1323, 183 East Main Street, Rochester, NY, 14604, US

(73) Assignee: Metal Work S.p.A.

(21) Appl. No.: 11/013,174

(22) Filed: Dec. 15, 2004

(30) Foreign Application Priority Data
Dec. 22, 2003 (IT) MI2003A 002561

(51) Int. Cl. B01D 50/00; B01D 59/50; B01D 45/00

(52) U.S. Cl. 55/315; 55/443

(57) ABSTRACT

A filter device for compressed-air systems comprises a body provided with an inlet for the air to be filtered and an outlet for the filtered air. Disposed between the inlet and outlet is a filter unit with a filtering cartridge and a condensate collection and discharge assembly. The filter unit is extended along a horizontal axis and the condensate assembly is disposed under the filter unit and downstream thereof.

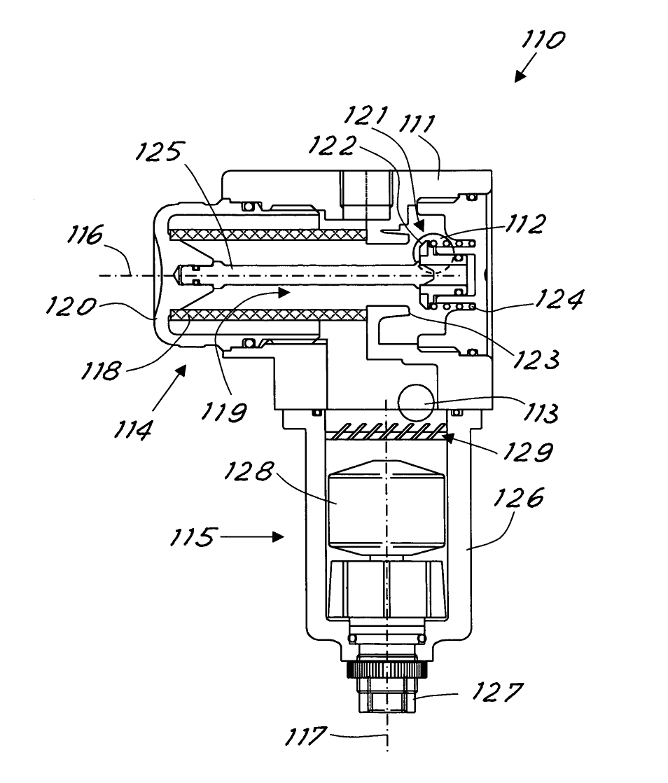

### BACKGROUND OF THE INVENTION

1. Field of the Invention

The present invention relates to an innovative filter device for compressed-air pneumatic systems.

2. State of the Prior Art

It is known that in compressed-air pneumatic systems, it is required that the solid particles be filtered off from the air and the water condensate be separated from the flow before admission of air into the distributors and actuators. For this reason, a filter device is usually provided which is equipped with a replaceable filtering cartridge and with means for separation of the condensate, and automatic or manual means for the condensate discharge.

In known devices the servicing interventions, such as replacement of the filter cartridge, are difficult and often uncomfortable, above all when the unit is positioned in regions of uneasy access to the machine using it. In particular, for the condensate collection at the filter base, the cartridge is always vertically disposed in a cup under the air inlet, the air flow being radially directed from the outside to the inside of the cartridge itself. Such an arrangement creates problems in terms of vertical bulkiness that can he hardly resolved and uncomfortable operations are required even for unscrewing the filter cup.

In addition, also unresolved are some operational problems impairing the arrangement reliability. For example, the automatic condensate discharge arrangements are subjected to jamming in the presence of solid particles suspended in the air and are therefore often refused by a user.

It is a general aim of the present invention to obviate the above mentioned drawbacks by providing an efficient filter device, of easy placement, reduced bulkiness and easy accessibility above all for servicing operations and replacement of the cartridge and that, if equipped with an automatic condensate discharge device, is not subjected to jamming due to the presence of solid particles entrained into the device by the air flow.

### SUMMARY OF THE INVENTION

In view of the above aim therefore, in accordance with the invention, a filter device for compressed air systems has been devised which comprises a body provided with an inlet for the air to be filtered and an outlet for the filtered air, a filter unit with a filtering cartridge and a condensate collection and discharge assembly being disposed between the inlet and outlet, characterized in that the filter unit is extended along a horizontal axis and the condensate assembly is disposed under the filter unit and downstream thereof.

### BRIEF DESCRIPTION OF THE DRAWINGS

For better explaining the innovative principles of the present invention and the advantages it offers over the known art, a possible embodiment applying said principles will be described hereinafter, with the aid of the accompanying drawing in which the only figure shows a possible embodiment of the invention, given by way of example only.

### DETAILED DESCRIPTION OF THE INVENTION

With reference to the figure, a filter device made in accordance with the invention and generally denoted at 110 is shown in sectioned elevation side view. The device comprises a body 111 provided with an inlet 112 for the air to be filtered and an outlet 113 for the filtered air. Housed in the body 111 is a filter unit 114 and a condensate collection and discharge assembly 115.

In accordance with the principles of the invention, the filter unit 114 is extended along a horizontal axis 116 while the condensate assembly 115 is disposed under the filter unit and is extended along a vertical axis 117. The condensate assembly is placed downstream of the filter unit and the air flow radially passes through the filter from the inside to the outside.

In particular, the filter unit is provided with a suitable cylindrical filtering cartridge 118 received in a suitable seat 119 sealed by a screw threaded plug 120 of a horizontal axis 116 as well.

Advantageously, the air inlet 112 communicates with the cartridge inside 118 through an on-off valve 121 having a closure member 122 pushed to the closed position against an abutment 123 upon the thrust action of a spring 124. Axially present internally of the plug 120 is a rod 125 that, when the plug 120 is correctly screwed in place, keeps the valve open against the thrust action of spring 124.

The condensate assembly 115 comprises a cup 126 for collection of the condensate entrained through the filter. The cup has a lower exhaust outlet 127 that can be operated either manually (by means of a screw threaded plug or valve, for example) or, advantageously, in an automatic manner by a known float valve 128 that opens when the liquid level in the cup overcomes a pre-established threshold.

Present on the cup 126 top is a system consisting of inclined lamellae 129 such disposed that they are licked by the air flow directed towards the outlet 113 so as to separate the condensate from the flow itself and cause dripping of the condensate into the underlying cup.

At this point it is apparent that the intended purposes have been achieved. The horizontal arrangement of the filter, with front extraction, makes the device compact and easily placeable as well as of easy and quick servicing. In addition, the air flow passing through the filter cartridge from the inside to the outside makes the intercepted dirt remain within the cartridge when it is removed from its seat, thereby facilitating the cartridge replacement and making it quicker. The condensate separation after filtering also prevents the dirt particles from reaching the condensate assembly causing blocking or clogging of the discharge outlet. This ensures a high reliability of a possible advantageous self-discharge device.

The automatic closure of the incoming air flow when the filter plug is unscrewed avoids accidental air escape into the surrounding atmosphere and makes the filter replacement quicker and more comfortable. Since separated flow cut-off cocks are not required, the device is cheaper and less bulky.

Obviously, the above description of an embodiment applying the innovative principles of the present invention is given by way of example only and therefore must not be considered as a limitation of the scope of the patent rights herein claimed. The conformation and exact proportions and sizes of the different parts can vary depending on the specific practical requirements. The air inlet and outlet connectors can be manufactured in compliance with any desired known structure.

1. A filter device for compressed air systems comprising a body provided with an inlet for the air to be filtered and an outlet for the filtered air, a filter unit with a filtering cartridge and a condensate collection and discharge assembly being disposed between the inlet and outlet, characterized in that the filter unit is extended along a horizontal axis and the condensate assembly is disposed under the filter unit and downstream thereof.

2. A device as claimed in claim 1, characterized in that the condensate assembly is extended along a vertical axis.

3. A device as claimed in claim 1, characterized in that the air inlet communicates with the inside of the filtering cartridge so that the air flow passes through it from the inside to the outside.

4. A device as claimed in claim 1, characterized in that the filtering cartridge is of cylindrical shape and is received in a suitable seat in the body, which seat is sealed by a screw threaded plug also having a horizontal axis.

5. A device as claimed in claim 3, characterized in that the air inlet communicates with the inside of the cartridge through an on-off valve that closes on opening to the external environment of the seat receiving the filtering cartridge, for removal of the cartridge.

6. A device as claimed in claim 5, characterized in that the filtering cartridge is of cylindrical shape and is received in a suitable seat in the body, which seat is sealed by a screw threaded plug also having a horizontal axis and the on-off valve comprises a closure member pushed to the closed position by a spring, and in that axially projecting from the inside of said plug is a rod that, after axially passing through the cartridge, pushes the closure member to the open position when the plug is in the position for sealing of the seat.

7. A device as claimed in claim 1, characterized in that the condensate assembly comprises a cup for collection of the condensate entrained through the filter and provided with a lower exhaust outlet.

8. A device as claimed in claim 7, characterized in that the exhaust outlet is provided with an automatic float valve opening when the liquid level in the cup exceeds a pre-established threshold.

9. A device as claimed in claim 7, characterized in that on the cup top there is the presence of a system consisting of inclined lamellae such disposed that they are licked by the air flow directed towards the outlet, so as to separate the condensate from the flow itself and cause dripping of the condensate into the underlying cup.
